(19) United States
(12) Patent Application Publication
(10) Pub. No.: US 2021/0252783 A1
(43) Pub. Date: Aug. 19, 2021

(54) Thermoplastic Mold with Implicit Registration

(71) Applicant: Arevo, Inc., Milpitas, CA (US)

(72) Inventors: Sushrut Shrikant Pavanaskar, Castro Valley, CA (US); Magda Zydzik, San Jose, CA (US)

(73) Assignee: Arevo, Inc., Milpitas, CA (US)

(21) Appl. No.: 16/792,156

(22) Filed: Feb. 14, 2020

(51) Int. Cl. B29C 64/245; B33Y 10/00; B33Y 80/00; B29C 64/118; B33Y 30/00; B33Y 70/00

(52) U.S. Cl. CPC B29C 64/245; B33Y 10/00; B33Y 80/00; B29K 2101/12; B33Y 30/00; B33Y 70/00; B29C 64/118

(57) ABSTRACT

A build plate, a mold, a sheet of perforated metal foil, and a sheet of pre-preg fibers are disclosed for use in 3D printers. The build plate and mold are designed so that the build surface of the mold is automatically and implicitly registered in the coordinate system of the printer. The mold, the sheet of perforated metal foil, and the sheet of pre-preg fibers provide a mechanism for precisely controlling the amount of adhesion experienced by the nascent article of manufacture at each location of the build surface.

### CROSS REFERENCE TO RELATED APPLICATIONS

This application is related to U.S. Ser. No. ______, entitled “Thermoplastic Mold with Tunable Adhesion,” filed on the same day as this application (Attorney Docket: 3019-243us1), which application is incorporated by reference.

### FIELD OF THE INVENTION

The present invention relates to additive manufacturing in general, and, more particularly, to additive manufacturing processes that use segments of thermoplastic filament as the fundamental unit of printing.

### BACKGROUND OF THE INVENTION

In the same way that a building can be constructed by successively depositing bricks on top of one another, it is well known in the field of additive manufacturing that an article of manufacture can be printed by successively depositing segments of thermoplastic filament on top of one another.

In some ways, a segment of thermoplastic filament is similar to spaghetti. When the temperature of a thermoplastic filament is below its resin softening point, the filament is stiff and not tacky—like a dry spaghetti. In contrast, when the temperature of the filament is above its resin softening point but below its melting point, the filament is flexible and sticky—like a wet spaghetti.

There are some key differences between bricks and thermoplastic filament. First, most bricks in a building have the same size. In contrast, the length of each segment of filament is custom cut, and there can be a wide disparity in their lengths. Second, bricks do not adhere to each other, and, therefore an adhesive compound—typically mortar—is used to bind them together. In contrast, segments of filaments will weld to each other if they are heated above their resin softening point and pressed together until they cool. Third, bricks are not flexible but thermoplastic filament can be easily formed into any two- or three-dimensional curve.

In the field of additive manufacturing, printing articles of manufacture from segments of thermoplastic filament has many advantages but it presents many challenges too.

### SUMMARY OF THE INVENTION

Some embodiments of the present invention enable the printing of an article of manufacture without some of the costs and disadvantages for doing so in the prior art.

For example, when a thermoplastic article of manufacture is printed onto a build surface (e.g., a build plate, mold, etc.), the article and the build surface can adhere, which makes separating them difficult. The prior art comprises many mold-release compounds which limit the adhesion, but that adhesion is advantageous in additive manufacturing. The illustrative embodiment addresses this issue by giving the operator of the printer a mechanism for precisely controlling the amount of adhesion at each location on the build surface.

Furthermore, when a thermoplastic article of manufacture is printed onto a build surface, the build surface must be registered in the coordinate system of the printer. This process is time consuming and susceptible to errors. The illustrative embodiment addresses this issue by providing a build surface that automatically and implicitly registers the build surface—whether planar or non-planar—in the coordinate system.

In particular, the illustrative embodiment provides a build surface that is capable of:
(i) providing vertical stability (e.g., structural support, etc.) to the article during printing; and
(ii) providing lateral stability to the article during printing (i.e., providing a surface onto which the first layer of thermoplastic filaments can be anchored so that they don't slide around); and
(iii) imparting a contour—either planar or non-planar—to that portion of the article that is adjacent to the build surface, which is advantageous because it expedites printing, obviates temporary support structures, and conserves thermoplastic filament; and
(iv) being automatically and implicitly registered in the coordinate system of the printer; and
(v) being easily separated from the article of manufacture after printing is complete. The illustrative embodiment accomplishes these with the combination of a novel build plate and mold.

In accordance with the illustrative embodiment, the build plate is a rigid aluminum alloy table that comprises an obverse side and a reverse side. The obverse side of the build plate defines the build volume of the printer, and, therefore, the coordinate system of the build volume.

The mold is a thermoplastic structure that comprises an obverse side and a reverse side. The obverse side of the build plate and the reverse side of the mold are congruent surfaces that comprise a system of mating keyways and splines that ensure that the mold can only be affixed to the build plate at one lateral location and one angular orientation. This ensures that when the reverse side of the mold is steadfastly affixed to the obverse side of the build plate the obverse side of the mold is implicitly registered in the coordinate system of the printer.

The obverse side of the mold—if not the entire mold—comprises a thermoplastic (e.g., polycarbonate, etc.) to which a sheet of composite pre-preg fibers can be thermally welded. Adjacent to the obverse side of the mold is a sheet of metal foil, which comprises an obverse side, a reverse side, and a hexagonal lattice of thru-holes between the obverse side and the reverse side. The reverse side of the sheet of metal foil is adjacent to the obverse side of the mold.

Adjacent to the sheet of metal foil is a sheet of thermoplastic composite pre-preg fibers, which comprises an obverse side and a reverse side. The reverse side of the sheet of composite fibers is adjacent to the obverse side of the sheet of metal foil.

During printing, the printer heats a segment of filament and a region of the sheet of composite fibers. The heat in the sheet of composite fibers radiates into the sheet of metal foil and into the mold. Sufficient heat is applied so that the temperature of the filament, the region of the sheet of composite fibers, and the adjacent region of the mold are all raised above their resin softening points.

The printer then deposits the filament onto the sheet of composite fibers, and immediately thereafter—while the filament, the region of the sheet of composite fibers and the adjacent region of the mold are still above their resin softening points—tamps the filament onto the obverse side of the sheet of composite fibers. This ensures that the filament and the sheet of composite fibers weld to each other.

If, however, there is a thru-hole in the sheet of metal foil on the reverse side of the sheet of composite fibers, the act of tamping also pushes the sheet of composite fibers through the thru-hole and into contact with the obverse side of the mold. This ensures that the sheet of composite fibers and the mold weld to each other and has the net effect of tacking that small region of the sheet of composite fibers—and the nascent article of manufacture—to the mold. This provides vertical and horizontal stability to the nascent article.

In contrast, if there is no thru-hole in the sheet of metal foil, the act of tamping does not weld the sheet of composite fibers to the mold. Therefore, the operator of the printer can precisely control (i.e., “tune”) where the build surface and the article adhere and how much they adhere by choosing the size, shape, and location of the thru-holes in the sheet of metal foil.

### BRIEF DESCRIPTION OF THE DRAWINGS

FIG. 1 depicts a front orthographic illustration of the salient components of additive manufacturing system 100 in accordance with the illustrative embodiment of the present invention.

FIG. 2a depicts an orthogonal top view of build plate 105 in accordance with the illustrative embodiment of the present invention.

FIG. 2b depicts an orthogonal front view of build plate 105 in accordance with the illustrative embodiment of the present invention.

FIG. 2c depicts an orthogonal side view of build plate 105 in accordance with the illustrative embodiment of the present invention.

FIG. 3a depicts an orthographic top view of mold 116 in accordance with the illustrative embodiment.

FIG. 3b depicts an orthographic front view of mold 116 in accordance with the illustrative embodiment.

FIG. 3c depicts an orthographic side view of mold 116 in accordance with the illustrative embodiment.

FIG. 4 depicts an orthographic top view of the size, shape, and location of the thru-holes in a region of sheet of metal foil 117.

FIG. 5 depicts a flowchart of the salient tasks performed in accordance with the illustrative embodiment of the present invention.

FIG. 6 depicts a flowchart of the salient tasks performed in accordance with task 501 of the illustrative embodiment.

FIG. 7 depicts a flowchart of the salient tasks performed in accordance with task 502 of the illustrative embodiment.

FIG. 8 depicts a graph of the Goldilocks Zone for the thermal conduction transfer efficiency and stiffness k of sheet of metal foil 117.

### DEFINITIONS

Printer—For the purposes of this specification, a “printer” is defined as an additive manufacturing system or an additive and subtractive manufacturing system.

Printing—For the purposes of this specification, the infinitive “to print” and its inflected forms is defined as to fabricate. The act of fabrication is widely called “printing” in the field of additive manufacturing.

Resin Softening Point—For the purposes of this specification the phrase “resin softening point” is defined as the temperature at which the resin softens beyond some arbitrary softness.

### DETAILED DESCRIPTION

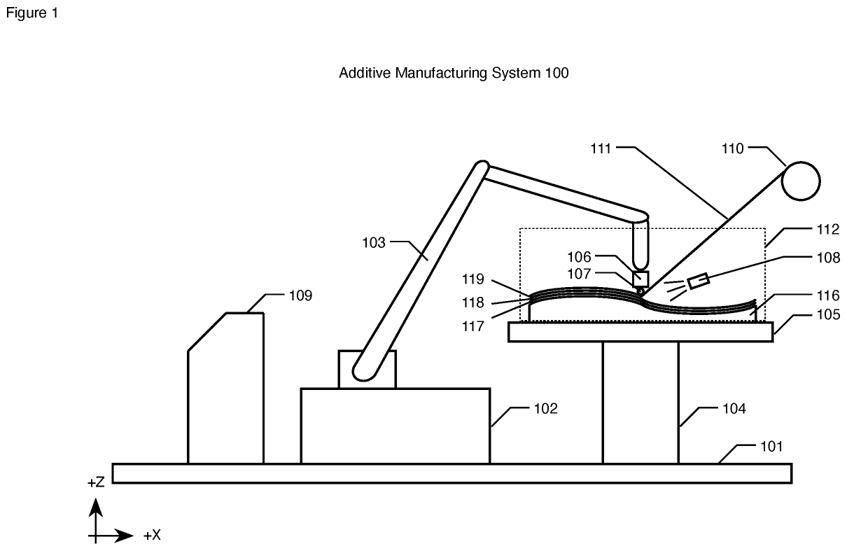

FIG. 1 depicts a front orthographic illustration of the salient components of additive manufacturing system 100 in accordance with the illustrative embodiment of the present invention. The purpose of additive manufacturing system 100 is to print an article of manufacturing by successively depositing finite segments of fiber-reinforced thermoplastic filament on top of each other in a prescribed geometry.

Additive manufacturing system 100 comprises: platform 101, robot mount 102, robot arm 103, build plate support 104, build plate 105, deposition head 106, tamping tool 107, deposition heater 108, controller 109, filament reel 110, undeposited filament 111, build volume 112, mold 116, sheet of metal foil 117, sheet of composite fibers 118, and deposited filament 119.

Platform 101 is a rigid metal structure that ensures that the relative spatial relationship of robot mount 102, robot arm 103, deposition head 106, tamping tool 107, and deposition heater 108 are knowable with respect to build-plate support 104, build plate 105, mold 116, and deposited filament 119. It will be clear to those skilled in the art how to make and use platform 101.

Robot mount 102 is a rigid, massive, and stable support for robot arm 103. It will be clear to those skilled in the art how to make and use robot mount 102.

Robot arm 103 comprises a six-axis mechanical arm that is under the control of controller 109. A non-limiting example of robot arm 103 is the IRB 4600 robot offered by ABB Group of Stockholm, Sweden. Robot arm 103 is capable of depositing a segment of fiber-reinforced thermoplastic filament from any three-dimensional coordinate in build volume 112 to any other three-dimensional coordinate in build volume 112 with deposition head 106 at any approach angle. Robot arm 103 can move tamping tool 107 in:
i. the +X direction,
ii. the −X direction,
iii. the +Y direction,
iv. the −Y direction,
v. the +Z direction,
vi. the −Z direction, and
vii. any combination of i, ii, iii, iv, v, and vi,
   while rotating the approach angle of tamping tool 107 around any line, any planar curve, and any non-planar curve within build volume 112. It will be clear to those skilled in the art how to make and use robot arm 103. Furthermore, it will be clear to those skilled in the art, after reading this disclosure, how to make and use alternative embodiments of the present invention that comprise a gantry-style robot.

Build plate support 104 is a rigid, massive, and stable support for build plate 105. Build plate support 104 comprises a stepper motor—under the control of controller 109—that is capable of rotating build plate 105 (and everything resting on build plate 105) around an axis that is normal to the X-Y plane. It will be clear to those skilled in the art how to make and use build plate support 104.

Build plate 105 is a rigid aluminum-alloy support onto which mold 116 is steadfastly affixed so that mold 116 (and everything resting or affixed to mold 116) cannot move or rotate independently of build plate 105. In accordance with the illustrative embodiment, the location and position of build plate 105 defines build volume 112 and the three-dimensional coordinate system for build volume 112. All spatial references for printing of the article of manufacture are specified in that coordinate system. If build plate 105 is rotated by build plate support 104—under the direction of controller 109—then the coordinate system is rotated as well. If build plate 105 is translated by build plate support 104—under the direction of controller 109—then the coordinate system is translated was well.

Build plate 105 comprises threaded thru-holes, and the obverse side of build plate 105 comprises keyways—and mold 116 comprises corresponding unthreaded thru-holes, and the reverse side of mold 116 comprises corresponding splines—to ensure that the reverse side of mold 116 can only fit into the obverse side of build plate 105 in one position. Therefore, steadfastly affixing (e.g., bolting, clamping, pinning, etc.) mold 116 onto build plate 105 implicitly registers mold 116 in the coordinate system of build volume 112. Build plate 105 is described in detail below and in the accompanying figures.

Deposition head 106 comprises all of the hardware (e.g., tamping tool 107 and deposition heater 108, etc.) necessary to deposit undeposited filament 111 in the desired position onto sheet of composite fibers 118 (and/or onto previously-deposited filaments as the case may be). Deposition head 106 is described in detail in:
(i) U.S. Pat. No. 10,195,786, entitled “Filament Heating in 3D Printing Systems,” issued on Feb. 5, 2019 (attorney docket 3019-115us1); and
(ii) U.S. Pat. No. 10,046,511, entitled “Alleviating Torsional Forces on Fiber-Reinforced Thermoplastic Filament,” issued on Aug. 14, 2018 (attorney docket 3019-143us1); and
(iii) U.S. Pat. No. 10,076,870, entitled “Filament Guide,” issued on Sep. 18, 2018 (attorney docket 3019-142us1); and
(iv) pending U.S. patent application Ser. No. 15/854,676, entitled “Depositing Arced Regions of Fiber-Reinforced Thermoplastic Filament,” filed Dec. 26, 2017 (attorney docket 3019-157us1); and
(v) pending U.S. patent application Ser. No. 16/505,541, filed on Jul. 8, 2019 and entitled “Adding a Segment of Fiber-Reinforced Thermoplastic Filament in a Curve” (attorney docket 3019-201us1); and
(vi) pending U.S. patent application Ser. No. 16/690,765, filed on Nov. 21, 2019 and entitled “Heater for Thermoplastic Filament and Workpiece” (attorney docket 3019-204us1),
   all of which are incorporated by reference. It will be clear to those skilled in the art how to make and use deposition head 106.

Tamping Tool 107 is a stainless-steel cylinder that rolls and presses undeposited filament 111 onto the obverse side sheet of composite fibers 118 or onto deposited filament 119 (as the case may be) to eliminate voids and ensure adhesion with sheet of composite fibers 118 (and/or previously-deposited filaments as the case may be). It will be clear to those skilled in the art how to make and use tamping tool 107.

Deposition heater 108 is an optical heater that:
(i) directly heats (with electromagnetic radiation) a region of undeposited filament 111 just before that region of undeposited filament 111 is deposited and tamped onto the obverse side of sheet of composite fibers 118 (and/or previously-deposited filaments as the case may be), and
(ii) directly heats (with electromagnetic radiation) the obverse side of a region of sheet of composite fibers 118 (and/or previously-deposited filaments as the case may be) just before undeposited filament 111 is deposited and tamped, and
(iii) indirectly heats (with thermal conduction from the obverse side of the region of sheet of composite fibers 118) the reverse side of the region of sheet of composite fibers 118, and
(iv) indirectly heats (with thermal conduction from the reverse side of the region of sheet of composite fibers 118) the obverse side of a region of sheet of metal foil 117, and
(iv) indirectly heats (with thermal conduction from the reverse side of the region of sheet of metal foil 117) the obverse side of a region of mold 116.

When undeposited filament 111, the region of sheet of composite fibers 118, and the obverse side of the region of mold 116 are all headed above their resin softening point, the pressure of tamping tool 107 facilitates:
(i) the thermal welding of undeposited filament 111 onto the obverse side of the region of sheet of composite fibers 118 (and/or previously-deposited filaments as the case may be), and
(ii) the thermal welding of the reverse side of the region of sheet of composite fibers 118 to the obverse side of the region of mold 116 through one of more of the thru-holes in sheet of metal foil 117.

It will be clear to those skilled in the art, after reading this disclosure and the incorporated documents, how to make and use deposition head 106, tamping tool 107, and deposition heater 108.

Controller 109 comprises the hardware and software necessary to direct robot arm 103, deposition head 106, tamping tool 107, deposition heater 108, and build plate support 104, in order to print an article of manufacture. It will be clear to those skilled in the art how to make and use controller 109.

Filament reel 110 is a circular reel that stores 1000 meters of undeposited filament 111 and feeds that undeposited filament 111 to deposition head 106. It will be clear to those skilled in the art how to make and use filament reel 110.

Undeposited filament 111 comprises a tow of reinforcing fibers that is substantially parallel to its longitudinal axis. In accordance with the illustrative embodiments, undeposited filament 111 comprises a cylindrical towpreg of contiguous 12K carbon fiber that is impregnated with thermoplastic resin. The cross-section of undeposited filament 111 is circular and has a diameter of 200 μm.

In accordance with the illustrative embodiment, undeposited filament 111 comprises contiguous carbon fiber, but it will be clear to those skilled in the art, after reading this disclosure, how to make and use alternative embodiments of the present invention in which undeposited filament 111 has a different fiber composition.

It will be clear to those skilled in the art, after reading this disclosure, how to make and use alternative embodiments of the present invention in which undeposited filament 111 comprises a different number of fibers (e.g., 1K, 3K, 6K, 24K, etc.). It will be clear to those skilled in the art, after reading this disclosure, how to make and use alternative embodiments of the present invention in which the fibers in undeposited filament 111 are made of a different material (e.g., fiberglass, aramid, carbon nanotubes, etc.).

In accordance with the illustrative embodiments, the thermoplastic is, in general, a semi-crystalline polymer and, in particular, the polyaryletherketone (PAEK) known as polyetherketone (PEK). In accordance with some alternative embodiments of the present invention, the semi-crystalline material is the polyaryletherketone (PAEK), polyetheretherketone (PEEK), polyetherketoneketone (PEKK), polyetheretherketoneketone (PEEKK), or polyetherketoneetherketoneketone (PEKEKK).

In accordance with some alternative embodiments of the present invention, the semi-crystalline polymer is not a polyaryletherketone (PAEK) but another semi-crystalline thermoplastic (e.g., polyamide (PA), polybutylene terephthalate (PBT), poly(p-phenylene sulfide) (PPS), etc.) or a mixture of a semi-crystalline polymer and an amorphous polymer.

When the filament comprises a blend of an amorphous polymer with a semi-crystalline polymer, the semi-crystalline polymer can one of the aforementioned materials and the amorphous polymer can be a polyarylsulfone, such as polysulfone (PSU), polyethersulfone (PESU), polyphenylsulfone (PPSU), polyethersulfone (PES), or polyetherimide (PEI). In some additional embodiments, the amorphous polymer can be, for example and without limitation, polyphenylene oxides (PPOs), acrylonitrile butadiene styrene (ABS), methyl methacrylate acrylonitrile butadiene styrene copolymer (ABSi), polystyrene (PS), or polycarbonate (PC).

When the filament comprises a blend of an amorphous polymer with a semi-crystalline polymer, the weight ratio of semi-crystalline material to amorphous material can be in the range of about 50:50 to about 95:05, inclusive, or about 50:50 to about 90:10, inclusive. Preferably, the weight ratio of semi-crystalline material to amorphous material in the blend is between 60:40 and 80:20, inclusive. The ratio selected for any particular application may vary primarily as a function of the materials used and the properties desired for the printed article.

In some alternative embodiment of the present invention, the filament comprises a metal. For example, and without limitation, the filament can be a wire comprising stainless steel, Inconel (nickel/chrome), titanium, aluminum, cobalt chrome, copper, bronze, iron, precious metals (e.g., platinum, gold, silver, etc.).

Build volume 112 is the region in three-dimensional space in which robot arm 103 is capable of depositing and tamping undeposited filament 111. Deposited filament 119 exists completely within build volume 112.

Mold 116 is a three-dimensional volume of thermoplastic (e.g., polycarbonate, PAEK, PEK, PAEK, PEEK, PEKK, PEEKK, PEKEKK, etc.) that comprises two sides: an obverse side and a reverse side. In accordance with the illustrative embodiment, the obverse side of mold 116 is non-planar and provides a contour for forming the shape of a region of the article of manufacture. It will be clear to those skilled in the art, after reading this disclosure, how to make and use alternative embodiments of the present invention in which the obverse side of the mold is planar. In accordance with the illustrative embodiment, the reverse side of mold 116 comprises splines that correspond to the keyways in build plate 105, and mold 116 comprises unthreaded thru-holes that correspond to the threaded bolt holes in build plate 105. Mold 116 is described in detail below and in the accompanying figures.

Sheet of metal foil 117 is, as the name suggests, a sheet of metal foil. Sheet of metal foil 117 comprises two sides—designated the obverse side and the reverse side—and a plurality of thru-holes between the obverse side and the reverse side. The obverse side of sheet of metal foil 117 is adjacent to the reverse side of sheet of composite fibers 118, and the reverse side of sheet of metal foil 117 is adjacent to the obverse side of mold 116. The size, shape, and location of the thru-holes is described in detail below and in the accompanying figure.

Where there is a thru-hole in sheet of metal foil 117, the reverse side of sheet of composite fibers 118 can potentially become thermal welded to the obverse side of mold 116. Where the reverse side of the sheet of composite fibers 118 becomes welded to the obverse side of mold 116 through a thru-hole, the weld forms a structure called an “adhesive pillar,” which has the approximate shape of a hyperboloid of one sheet.

In contrast, where there is no thru-hole in a region of sheet of metal foil 117, the reverse side of sheet of composite fibers 118 cannot become welded to mold 116 at that region. These facts enable the designer of the article of manufacture to make a deliberate tradeoff between two mutually-incompatible goals.

As a first goal, at the end of printing, the article of manufacture (and sheet of composite fibers 118 to which it is welded) should quickly and easily separate from mold 116. This suggests that sheet of composite fibers 118 should not be welded to mold 116 anywhere, which would be achieved by having no thru-holes in sheet of metal foil 117. As a second goal, sheet of composite fibers 118—and the workpiece being deposited on it—must have lateral and vertical stability and conform perfectly to the contour of mold 116 during printing. This suggests that sheet of composite fibers 118 should be welded to mold 116 everywhere, which would be achieved at the extreme by eliminating sheet of metal foil 117 altogether or, alternatively, by including sheet of metal foil 117 and maximizing the total area of the thru-holes.

The designer is thus given the opportunity to tailor or tune the amount and location of welding of sheet of composite fibers 118 to mold 116 by choosing the size, shape, and location of the thru-holes in sheet of metal foil 117.

In accordance with the illustrative embodiment, sheet of metal foil 117 is tempered aluminum, but it will be clear to those skilled in the art, after reading this specification, how to make and use alternative embodiments of the present invention in which sheet of metal foil 117 comprises a different metal (e.g., copper, tin, steel, etc.) or is not tempered.

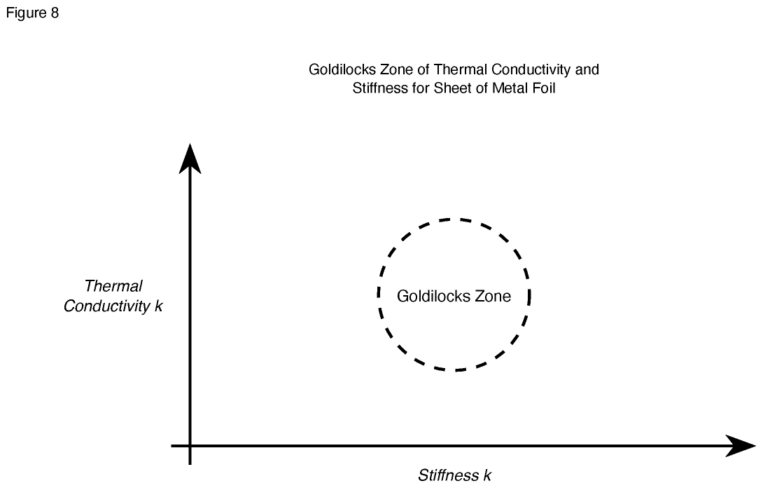

Sheet of metal foil 117 fits in the Goldilocks Zone of thermal conductivity k and stiffness k, as depicted in FIG. 8. Sheet of metal foil 117 must efficiently conduct thermal energy from its obverse side to its reverse side and to mold 116, which suggests that it should be thinner. Conversely, sheet of metal foil 117 must be sufficiently stiff so that it resists completely being crushed by tamping tool 106 by insufficiently stiff so that it deforms to allow sheet of composite fibers 118 to contact, and weld to, mold 116.

In accordance with the illustrative embodiment, sheet of metal foil 117 has a thickness T≈100 μm, although foil in the range of 50 μm≤T≤300 μm has yielded acceptable results, depending on the pressure of tamping tool 106 and the size of the thru-holes.

Sheet of composite fibers 118 is a sheet of fiber-reinforced thermoplastic, in well-known fashion and as commercially available. The desired properties of sheet of composite fibers 118 are:
(i) it readily absorbs electromagnetic radiation from deposition heater 106 so that its temperature rises above its resin softening point, and
(ii) it readily deforms and conforms to the contour of the obverse side of mold 116, and
(iii) it readily welds (i.e., adheres) to undeposited fiber 110, and
(iv) it readily transfers heat (through conduction) to sheet of metal foil 117, and
(v) it readily welds (i.e., adheres) to mold 116 through the thru-holes in sheet of metal foil 117.

In accordance with the illustrative embodiment, the reinforcing fiber is continuous carbon, but it will be clear to those skilled in the art, after reading this specification, how to make and use alternative embodiments of the present invention in which the reinforcing fiber is different (e.g., glass, metal, fiberglass, aramid, carbon nanotubes, etc.). In accordance with the illustrative embodiment, the reinforcing fibers are uni-directional, but it will be clear to those skilled in the art, after reading this disclosure, how to make and use alternative embodiments of the present invention in which the reinforcing fibers are not uni-directional (e.g., are woven, felted, etc.). In accordance with the illustrative embodiment, sheet of composite fibers 118 has a 60% fiber content, but it will be clear to those skilled in the art, after reading this disclosure, how to make and use alternative embodiments of the present invention in which the sheet has a different fiber content. In accordance with the illustrative embodiment, sheet of composite fibers 118 comprises the thermoplastic PEEK, but it will be clear to those skilled in the art, after reading this disclosure, how to make and use alternative embodiments of the present invention in which the sheet comprises a different thermoplastic. For example, a sheet of black polycarbonate can be used in place of sheet of composite fibers 118.

Deposited filament 119 is undeposited filament 111 after it has been deposited onto sheet of composite fibers 118 (and/or previously-deposited filaments as the case may be).

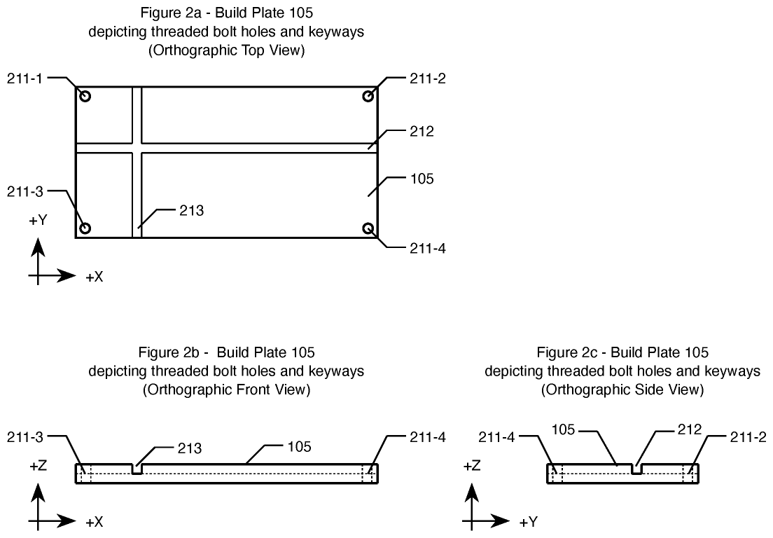

FIGS. 2a, 2b, and 2c depict orthographic top, front, and side views of build plate 105 in accordance with the illustrative embodiment.

Build plate 105 has a rectangular footprint and is 800 mm wide (i.e., in the Δx direction), 400 mm deep (i.e., the Δy direction), and 100 mm thick (i.e., in the Δz direction). Furthermore, the obverse side of build plate 105 comprises two 25 mm wide by 25 mm deep keyways—keyway 212 and keyway 213—that traverse the length and width, respectively, of build plate 105. Furthermore, build plate 105 comprises four threaded M7 bolt holes 211-1, 211-2, 211-3, and 211-4, as depicted.

Although the illustrative embodiment comprises two keyways and four threaded bolt holes, it will be clear to those skilled in the art, after reading this specification, how to make and use alternative embodiments of the present invention that comprise any system of keyways and splines bolt holes to physically constrain the mating of build plate 105 and mold 116.

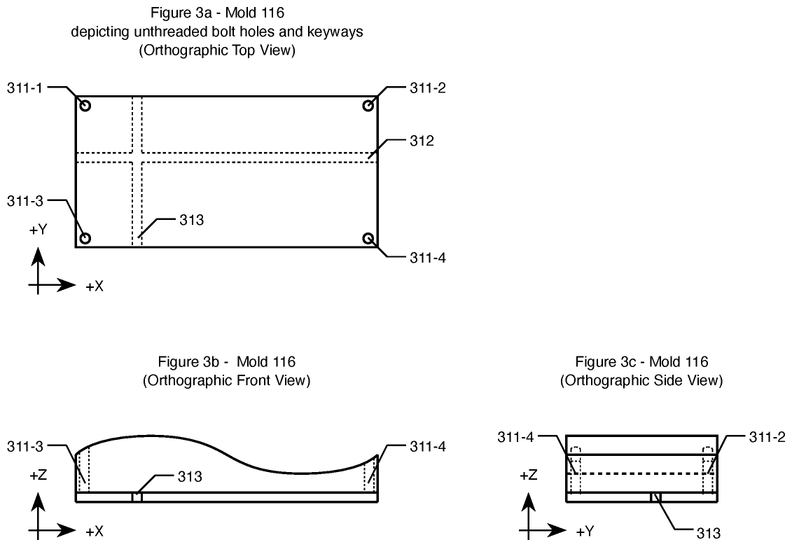

FIGS. 3a, 3b, and 3c depict orthographic top, front and side views of mold 116 in accordance with the illustrative embodiment.

Mold 116 has a rectangular footprint and is 800 mm wide (i.e., in the Δx direction), and 400 mm deep (i.e., the Δy direction). The reverse side of mold 116 comprises a 25 mm wide by 25 mm deep spline—spline 312—that traverses the length of mold 116 and that mates perfectly with keyway 212. The reverse side of mold 116 also comprises a 25 mm wide by 25 mm deep spline—spline 313—that traverses the width of mold 116 and that mates perfectly with keyway 313.

The obverse side of mold 116 is non-planar, continuous (i.e., comprises no discontinuities), and described by the equation:

$$z = s ( x , y ) = [ 50 sin ( \frac{2 π x}{800} ) + 100 ] mm \qquad Eq . ( 1 )$$

where x is a real number in the range 0≤x≤800.

Mold 116 also comprises four unthreaded through holes 311-1, 311-2, 311-3, and 311-4 through which M7 bolts are placed to affix mold 116 steadfastly to build plate 105.

Although mold 116 has a rectangular footprint, it will be clear to those skilled in the art, after reading this disclosure, how to make and use alternative embodiments of the present invention in which the supporting structure has any footprint.

Although mold 116 has a footprint of 800 mm×400 mm, it will be clear to those skilled in the art, after reading this disclosure, how to make and use alternative embodiments of the present invention of any size.

Although mold 116 has an obverse side that is non-planar, it will be clear to those skilled in the art, after reading this disclosure, how to make and use alternative embodiments of the present invention in which the obverse side has any form (e.g., planar, irregular, convex, concave, hemispherical, etc.).

Although mold 116 has an obverse side that is continuous, it will be clear to those skilled in the art, after reading this disclosure, how to make and use alternative embodiments of the present invention in which the obverse side comprises one or more discontinuities.

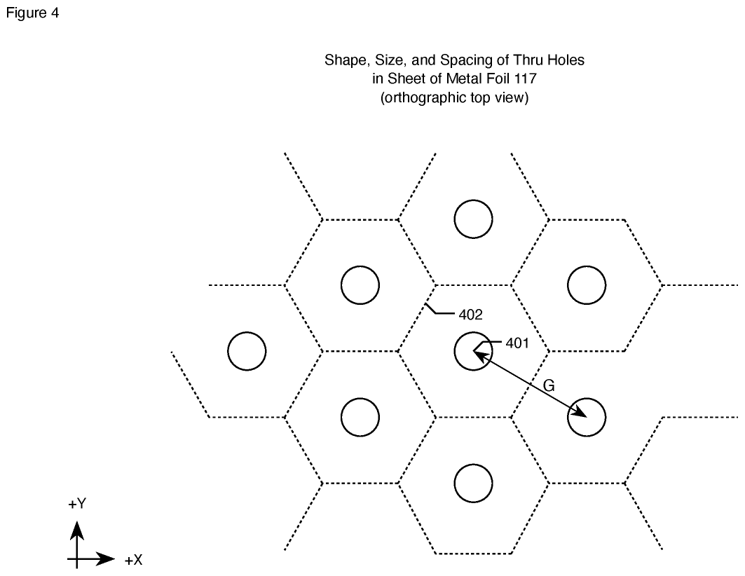

FIG. 4 depicts a schematic top view of the size, shape, and relative location of the thru-holes of sheet of metal foil 117. In particular, FIG. 4 depicts the profile of seven thru-holes, each of which is within a region of sheet of metal foil 117. As can be seen in FIG. 4, thru-hole 401 is within region 402.

In accordance with the illustrative embodiment, the amount of adhesion and the location of adhesion between sheet of composite fibers 118 and mold 116 is moderated by the size, shape, and location of the thru-holes and the size, shape, and location of the regions surrounding the respective thru-holes.

In accordance with the illustrative embodiment, all of sheet of metal foil 117 is logically partitioned into tiling of regions that are identical regular hexagons, and each region comprises a thru-hole at its center. The physical result is that sheet of metal foil is perforated with a regular hexagonal lattice of identical thru-holes. It will be clear to those skilled in the art, after reading this specification, how to make and use alternative embodiments of the present invention in which the sheet of metal foil is perforated with thru-holes of any size, shape, and location. For example, the size, shape, and density of thru-holes might be different in different portions of the sheet of metal foil, and it will be clear to those skilled in the art, after reading this specification, how to determine the appropriate size, shape, and location of those thru-holes.

In accordance with the illustrative embodiment, the thru-holes are cylindrical (i.e., the thru-holes have a round profile) with a diameter D of 3000 μm and center-to-center distance G of 6000 μm.

In accordance with the illustrative embodiment, the amount of adhesion in a region of sheet of metal foil 117 is designated by the “adhesion fraction” A. When the thru-holes are spaced on a regular hexagonal lattice with a center-to-center distance G and diameter of D, the adhesion fraction A is given by equation 2:

$$A = {π ( \frac{D}{2 G} )}^{2} \qquad Eq . ( 2 )$$

which for the illustrative embodiment equals:

$$A = {π ( \frac{D}{2 G} )}^{2} = {π ( \frac{3000 µm}{( 2 ) ( 6000 µm )} )}^{2} \approx 0.20$$

It will be clear to those skilled in the art, after reading this specification, how to make and use alternative embodiments of the present invention that have different values for A, D, and G. In general, however, the inventors of the present invention have discovered that adhesion fractions in the range 0.15≤A≤0.30 work well and correspond to diameters in the range of 2000 μm D 4000 μm and center-to-center distances G in the range of 5300 μm≤G≤6900 μm. When the adhesion fraction A is lower than 0.15, sheet of composite fibers 118 too often does not have the lateral and vertical stability it needs to enable the article of manufacture to be fabricated without dimensional problems. In contrast, when the adhesive fraction A is higher than 0.30, the task of separating the article of manufacture (and sheet of composite fibers 118) becomes extremely difficult.

It will be clear to those skilled in the art, after reading this disclosure, how to make and use alternative embodiments of the present invention in which the sheet of metal foil is perforated with any number of holes—whether in a pattern or not—and of any size, shape, and location.

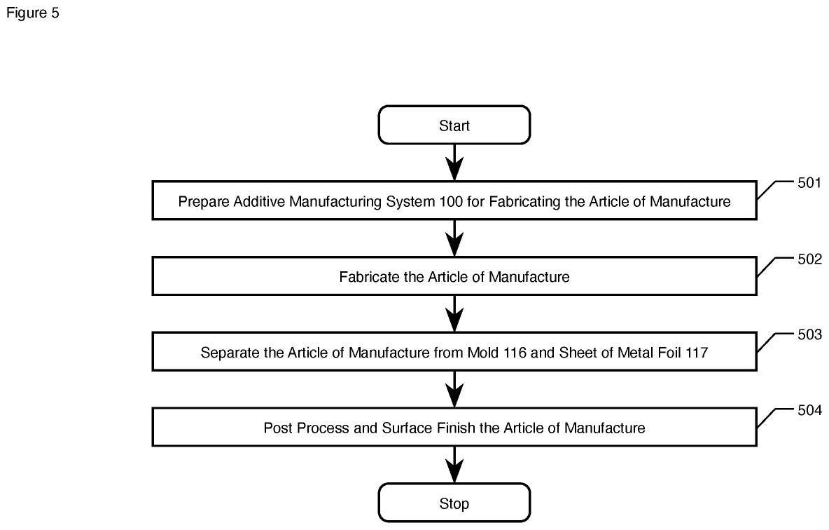

FIG. 5 depicts a flowchart of the salient tasks performed in accordance with the illustrative embodiment of the present invention.

At task 501, additive manufacturing system 100 is prepared for printing the article of manufacture. Task 501 is described in detail below and in the accompanying figure.

At task 502, additive manufacturing system prints the article of manufacture. Task 502 is described in detail below and in the accompanying figures.

At task 503, the article of manufacture is separated from mold 116 and sheet of metal foil 117. In accordance with the illustrative embodiment, the article of manufacture is separated from mold 116 by shearing the adhesive pillars between sheet of composite fibers 118 and mold 116 with a thin piano wire between sheet of metal foil 117 and sheet of composite fibers 118. It will be clear to those skilled in the art, after reading this disclosure, that there are alternative ways of separating the article of manufacture from mold 116 and sheet of metal foil 117. For example:
(i) chemically dissolving mold 116 and by peeling away sheet of metal foil 117, or, alternatively,
(ii) by shearing the adhesive pillars between sheet of composite fibers 118 and mold 116 with a thin piano wire between mold 117 and sheet of metal foil 117, and then peeling away sheet of metal foil 117, or alternatively,
(iii) by cleaving the article of manufacture from mold 116 with a wedge (i.e., successively stretching and rupturing the adhesive pillars from article of manufacture) and peeling away sheet of metal foil 117, or, alternatively,
(iv) by heating mold 116 above its resin softening point and peeling away sheet of metal foil 117.

It will be clear to those skilled in the art, after reading this disclosure, how to perform task 503.

At task 504, the article of manufacture is:
(i) sanded to remove the stubble of any adhesive pillars that remain, and
(ii) trimmed to remove any superfluous regions of sheet of composite fibers 118, and
(iii) surface finished (e.g., painted, etc.).

It will be clear to those skilled in the art, after reading this disclosure, how to perform task 504.

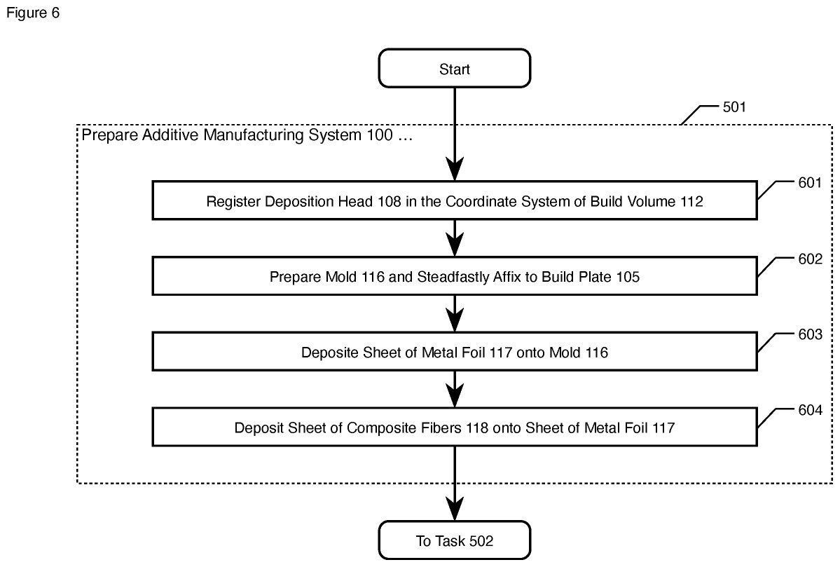

FIG. 6 depicts a flowchart of the salient tasks performed in accordance with task 501 of the illustrative embodiment.

At task 601, deposition head 108 is registered in the three-dimensional coordinate system of build plate 105. It will be clear to those skilled in the art how to accomplish task 601.

At task 602, mold 116 is prepared and steadfastly affixed to build plate 105 using M7 bolts so that spines 312 and 313 with keyways 212 and 213 mate, respectively. This implicitly registers the obverse side of mold 116 in the three-dimensional coordinate system of build volume 112 and obviates the necessity of explicit and physical registration with build plate 105. It will be clear to those skilled in the art, after reading this specification, how to accomplish task 602.

At task 603, sheet of metal foil 117 is deposited onto mold 116 so that the reverse side of sheet of metal foil 117 is adjacent to the obverse side of mold 116. In accordance with the illustrative embodiment, sheet of metal foil 117 is loosely affixed to mold 116 around the periphery using masking tape. It will be clear to those skilled in the art, after reading this specification, how to accomplish task 603.

At task 604, sheet of composite fibers 118 is deposited onto sheet of metal foil 117 so that the reverse side of sheet of composite fibers 118 is adjacent to the obverse side of sheet of metal foil 118. In accordance with the illustrative embodiment, sheet of composite fibers 118 is loosely affixed to mold 116 around the periphery using masking tape. It will be clear to those skilled in the art, after reading this specification, how to accomplish task 604.

After task 604, control proceeds to task 502.

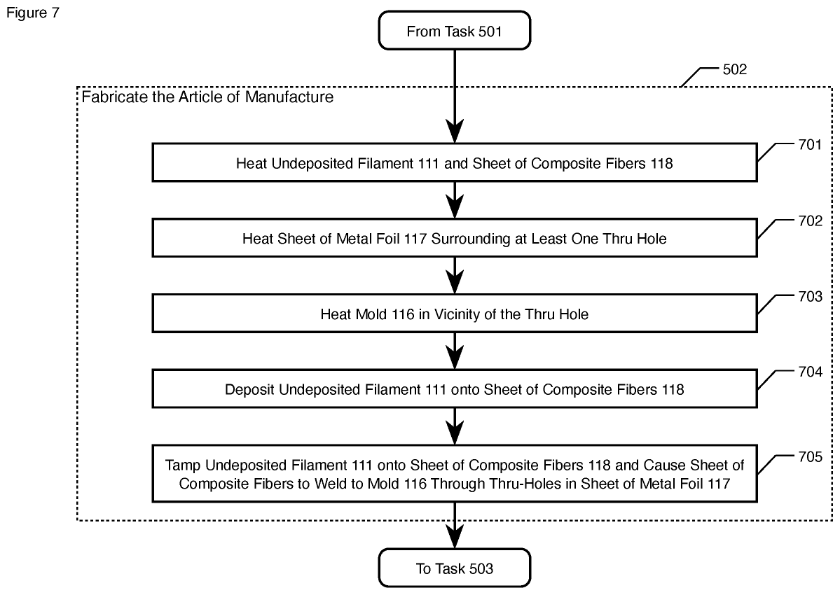

FIG. 7 depicts a flowchart of the salient tasks performed in accordance with task 502 of the illustrative embodiment.

At task 701, deposition heater 108 heats a region of undeposited filament 111 and the obverse side of a region of sheet of composite fibers 118 with electromagnetic radiation. This heats the region of undeposited filament 111 and the region of sheet of composite fibers 118 above their resin softening point. It will be clear to those skilled in the art, after reading this specification, how to accomplish task 701.

At task 702, heat in the region of sheet of composite fibers 118 transfers to an adjacent region of sheet of metal foil 117 through thermal conduction. It will be clear to those skilled in the art, after reading this specification, how to accomplish task 702.

At task 703, heat in the region of sheet of metal foil 117 transfers to an adjacent region of mold 116 through thermal conduction and raises its temperature above its resin softening point. It will be clear to those skilled in the art, after reading this specification, how to accomplish task 703.

At task 704, deposition head 106 deposits the heated region of undeposited filament 111 onto the obverse side of the region of sheet of composite fibers 118. It will be clear to those skilled in the art, after reading this specification, how to accomplish task 704.

At task 705, tamping tool 108 tamps the recently deposited region of undeposited filament 111 onto the obverse side of sheet of composite fibers 118 with sufficient force to cause the reverse side of the sheet of composite fibers 118 to come into contact with—and weld to—the obverse side of mold 116 through a thru-hole in sheet of metal foil 117. The resulting weld is known as an adhesive pillar, and it tacks sheet of composite fibers 118 to mold 116, which provides lateral and vertical stability to sheet of composite fibers 118. It will be clear to those skilled in the art, after reading this specification, how to accomplish task 705.

After task 705, control proceeds to task 503.

What is claimed is:

1. A method of printing an article of manufacture, the method comprising:
registering an end effector in the three-dimensional coordinate system of a build volume;
affixing a mold to the obverse side of the build plate, wherein the mold comprises:
(i) an obverse side that is non-planar, and
(ii) a reverse side that contacts the obverse side of the build plate, and
(iii) a first thermoplastic;
wherein the mold is affixed to the obverse side of the build plate at a translational location and an angular orientation so that the obverse side of the mold surface is implicitly registered in the three-dimensional coordinate system of the build volume;
depositing a sheet of metal foil on the mold, wherein the sheet of metal comprises:
(i) an obverse side, and
(ii) a reverse side that is adjacent to the mold, and
(iii) a thru-hole in a region of the sheet of metal foil, wherein the thru-hole traverses between the obverse side of the sheet of metal foil and the reverse side of the sheet of metal foil;
depositing a sheet of composite fibers onto the sheet of metal foil, wherein the sheet of composite fibers comprises:
(i) an obverse side, and
(ii) a reverse side that is adjacent to the obverse side of the sheet of metal foil, and
(iii) a second thermoplastic;
heating a thermoplastic filament and a region of the sheet of composite fibers with electromagnetic radiation, wherein the region of the sheet of composite fibers is adjacent to the region of the sheet of metal foil;
depositing the thermoplastic filament onto the obverse side of the region of the sheet of composite fibers; and
tamping the thermoplastic filament onto the onto the obverse side of the region of the sheet of composite fibers so that the reverse side of the region of the sheet of composite fibers welds to the thermoplastic mold through the thru-hole in the region of the sheet of metal foil.

2. The method of claim 1 wherein the obverse side of the build plate comprises a first keyway and a second keyway, and wherein the reverse side of the mold comprises a first spline and a second spline.

3. The method of claim 1 further comprising heating the region of the sheet of metal foil with thermal conduction from the reverse side of the region of the sheet of composite fibers.

4. The method of claim 3 further comprising heating a region of the thermoplastic mold adjacent to the region of the sheet of metal foil via thermal conduction from the reverse side of the region of the sheet of metal foil.

5. The method of claim 1 wherein the sheet of metal foil has a thickness in the range 50 μm T 300 μm.

6. The method of claim 1 wherein the adhesion fraction A of the sheet of metal foil is in the range of in the range 0.15≤A≤0.30.

7. The method of claim 1 wherein the first thru-hole is cylindrical and has a round profile with a diameter D in the range 2000 μm D 4000 μm.

8. The method of claim 1 wherein the first thru-hole has a round profile;
wherein the second thru-hole has a round profile; and
wherein the center-to-center distance G between the first thru-hole and the second thru-hole is in the range of 5300 μm G 6900 μm.

9. The method of claim 1 wherein the sheet of metal foil is aluminum.

10. The method of claim 1 wherein the thermoplastic mold comprises a thermoplastic selected from the group of polycarbonate, acrylonitrile butadiene styrene, polystyrene, and polyetherimide.

11. The method of claim 1 wherein the thermoplastic that is pre-impregnated into the sheet of composite fibers comprises a thermoplastic selected from the group of polyaryletherketone (PAEK), polyetheretherketone (PEEK), polyetherketoneketone (PEKK), polyetheretherketoneketone (PEEKK), and polyetherketoneetherketoneketone (PEKEKK).

12. The method of claim 1 wherein the thermoplastic filament comprises a thermoplastic selected from the group of polyaryletherketone (PAEK), polyetheretherketone (PEEK), polyetherketoneketone (PEKK), polyetheretherketoneketone (PEEKK), and polyetherketoneetherketoneketone (PEKEKK).

13. The method of claim 1 further comprising stripping the sheet of metal foil from the sheet of composite fibers.

14. An article of manufacture comprising:
a build plate that comprises a first keyway and a second keyway in an obverse face;
a mold that comprises:
(i) an obverse side, and
(ii) a reverse side that comprises a first spline that mates with the first keyway and a second spline that mates with the second keyway, and
(iii) a first thermoplastic; and
a sheet of metal foil that comprises:
(i) an obverse side, and
(ii) a reverse side that is adjacent to the obverse side of the mold, and
(iii) a thru-hole in a region of the sheet of metal foil, wherein the thru-hole traverses between the obverse side of the sheet of metal foil and the reverse side of the sheet of metal foil;
a sheet of composite fibers that comprises:
(i) an obverse side, and
(ii) a reverse side that is adjacent to the obverse side of the sheet of metal foil, and
(iii) a second thermoplastic, and
wherein the reverse side of the sheet of composite fibers is thermally welded to the mold through the thru-hole to form an adhesive pillar.

15. The article of manufacture of claim 14 wherein the sheet of metal foil has a thickness in the range 50 μm T 300 μm.

16. The article of manufacture of claim 14 wherein the adhesion fraction A of the sheet of metal foil is in the range of in the range 0.15≤A≤0.30.

17. The article of manufacture of claim 14 wherein the first thru-hole is cylindrical and has a round profile with a diameter D in the range 2000 μm D 4000 μm.

18. The article of manufacture of claim 14 wherein the sheet of metal foil is aluminum.

19. The article of manufacture of claim 14 wherein the thermoplastic mold comprises a thermoplastic selected from the group of polycarbonate, acrylonitrile butadiene styrene, polystyrene, and polyetherimide.

20. The article of manufacture of claim 14 wherein the thermoplastic that is pre-impregnated into the sheet of composite fibers comprises a thermoplastic selected from the group of polyaryletherketone (PAEK), polyetheretherketone (PEEK), polyetherketoneketone (PEKK), polyetheretherketoneketone (PEEKK), and polyetherketoneetherketoneketone (PEKEKK).

21. The article of manufacture of claim 14 wherein the thermoplastic filament comprises a thermoplastic selected from the group of polyaryletherketone (PAEK), polyetheretherketone (PEEK), polyetherketoneketone (PEKK), polyetheretherketoneketone (PEEKK), and polyetherketoneetherketoneketone (PEKEKK).
